(19) United States
(12) Patent Application Publication
(10) Pub. No.: US 2024/0416323 A1
(43) Pub. Date: Dec. 19, 2024

(54) RUTHENIUM CATALYSTS FOR LOW-TEMPERATURE AND LOW-PRESSURE AMMONIA SYNTHESIS

(71) Applicant: University of South Carolina, Columbia, SC (US)

(72) Inventors: Samuel Drummond, Columbia, SC (US); Jochen Lauterbach, Columbia, SC (US); Jennifer Naglic, Chapin, SC (US)

(73) Assignee: University of South Carolina, Columbia, SC (US)

(21) Appl. No.: 18/733,335

(22) Filed: Jun. 4, 2024

Related U.S. Application Data
(60) Provisional application No. 63/508,431, filed on Jun. 15, 2023.

(51) Int. Cl. B01J 23/58; B01J 23/46; B01J 35/30; C01C 1/04

(52) U.S. Cl. CPC B01J 23/58; B01J 23/462; B01J 35/394; C01C 1/0411

(57) ABSTRACT

A catalyst including ruthenium, a promoter metal, and a second metal, optionally disposed on a support, and methods of using the catalyst to catalyze the formation of ammonia.

### CROSS-REFERENCE TO RELATED APPLICATIONS

Priority is hereby claimed to provisional application Ser. No. 63/508,431, filed Jun. 15, 2023, which is incorporated herein by reference.

### FEDERAL FUNDING STATEMENT

This invention was made with government support under Grant Number DE-EE0009409, awarded by the Department of Energy. The government has certain rights in the invention.

### BACKGROUND

Heterogeneous catalysts are conventionally disposed on a supporting material having a very high surface area. The support serves to disperse the catalytically active material uniformly over a very large and reactant-accessible surface area. The support also functions as a physically and thermally stable foundation that enables the catalytically active materials (which can be very expensive) to be recycled and regenerated with minimal losses. Support materials are typically inactive (or relatively inactive) as compared to the catalytically active material deposited on the surface of the support material. But in some instances, the support itself also has a notable effect (good or bad) on catalytic activity. Refractory oxides, notably oxides of silicon, magnesium, titanium, aluminum, and zirconium (i.e., silica, magnesia, titania, alumina, and zirconia, respectively) are well known and widely used catalyst supports. Activated carbon is also a widely used catalyst support.

Two main methods are used to prepare supported catalysts impregnation and co-precipitation. In the impregnation method, a suspension of the solid support is treated with a solution of a pre-catalyst. This deposits the pre-catalyst onto/into the porous support. The solution is removed and the resulting material is then activated (chemically and/or thermally) under conditions that convert the pre-catalyst to an active state. In the co-precipitation method, the catalytically active material and the support (or precursors of both) are dissolved in a homogeneous solution and precipitated simultaneously (for example, by acid or base addition or evaporation of the solvent). The catalytically active material and the support precipitate together. The initially precipitated material is conventionally further processed, such as by calcining, to yield the final supported catalyst.

The Haber-Bosch process to make ammonia directly from molecular hydrogen and nitrogen revolutionized world-wide farming practices. With the scale-up of the Haber-Bosch process, for the first time in human history nitrogen-based fertilizers could be made relatively cheaply and on an industrial scale. The original process is described in U.S. Pat. No. 1,202,995, filed Aug. 13, 1909, and issued Oct. 31, 1916, to Haber and Le Rossignol.

The shortcomings of the Haber-Bosch process, however, are well known. Conventionally, the process is conducted using iron-based catalysts at very high pressures (about 150 to about 200 bar) and relatively high temperatures (about 400 to about 450° C.). Achieving these very extreme reaction conditions consumes an incredible amount of energy. Something on the order of 2% of the world-wide production of electricity annually is consumed by producing nitrogen via the Haber-Bosch process. As a predictable result, research into improving the Haber-Bosch process to make it run at lower temperatures and pressures has been a continuous and crowded field ever since Haber first described the process in 1908.

Ruthenium catalysts have been used due to their ability to operate under milder conditions. See, for example, Jiang et al., U.S. Pat. No. 11,517,882, issued Dec. 6, 2022, which describes a multi-layer catalyst that includes ruthenium. This is a complex catalyst comprising a ruthenium nanoparticle as a core which is covered with a first shell and a second shell sequentially, wherein the first shell consists of a barium nanoparticle, and the second shell consists of a metal oxide. The entire, multi-layer catalyst composition is deposited on a graphitized activated carbon support. The catalyst further comprises an electron promoter which is an oxide of an alkali metal.

Hosono et al., U.S. Pat. No. 11,235,310, describes a method for manufacturing an ammonia synthesis catalyst. The method includes a first step of preparing a mixed calcium oxide/aluminum oxide support having a specific surface area of 5 m²/g or more. A ruthenium-containing compound is then supported on the calcium oxide/aluminum oxide support. The pre-catalyst is then subjected to a reduction process to yield the final catalyst.

Forni et al., U.S. Pat. No. 7,115,239, describes catalysts for ammonia synthesis based on ruthenium deposited on a crystalline graphite support having a BET specific surface area of more than 10 m²/g. The catalyst further contains barium, cesium, and potassium as added as promoters.

See also two related patents to Muhler et al., U.S. Pat. No. 6,559,093, issued May 6, 2003, and a divisional of it, U.S. Pat. No. 6,673,732, issued Jan. 6, 2004. These two patents describe an ammonia synthesis catalyst comprising ruthenium, promoted with one or more additional metals selected from alkali metals, alkaline earth metals and lanthanides. The catalytically active metals are supported on a magnesium oxide support having a specific surface area of at least 40 m²/g. The ruthenium concentration is between 3 wt % and 20 wt % and the promoter metal content is between 0.2 to 5.0 mole of promoter per mole of ruthenium.

Andrew et al., U.S. Pat. No. 4,698,325, issued Oct. 6, 1987, describes an ammonia synthesis catalyst precursor having a BET surface area of at least 10 m²/g. The catalyst is a mixture of finely divided particles of a reducible compound of at least one metal from “Group VII” of the Periodic Table (i.e., current Groups 8, 9, and 10: iron, ruthenium, osmium, and hassium; cobalt, rhodium, iridium, and meitnerium; and nickel, palladium, platinum, and darmstadtium). The catalyst further includes finely divided particles of carbon and/or an oxidic material that is not easily reduced, and an alkali metal acid salt promoter.

There remains, however, a long-felt and unmet need for heterogeneous catalysts that improve the Haber-Bosch process for making ammonia.

### SUMMARY

Disclosed and claimed herein is a catalyst comprising ruthenium (Ru), a promoter metal, and a second metal. The promoter metal is preferably (but non-exclusively) selected from the group consisting of Li, Na, K, Rb, and Cs. The second metal is preferably (but non-exclusively) a transition metal. Preferred metals for use as the second metal include (but are not limited to) Ag, Al, Ba, Bi, Ca, Cd, Ce, Co, Cr, Cu, Cs, Dy, Er, Eu, Fe, Ga, Gd, Hf, Ho, In, Ir, K, La, Li, Lu, Mg, Mn, Na, Nd, Ni, Pb, Rb, Re, Sc, Sm, Sn, Sr, Tb, Tm, V, Y, Yb, Zn, and Zr. In some versions, the second metal is selected from the group consisting of Ba, Dy, Eu, Gd, Hf, K, Lu, Sc, Sr, and Y.

The catalyst may optionally be disposed on a support. When the catalyst is disposed on a support, an exemplary, non-limiting, and preferred support comprises praseodymium oxide.

The preferred promoter metal is cesium (Cs). The preferred second metal is barium (Ba). The catalyst preferably (but not necessarily) comprises at least 0.2 wt % but less than 3 wt % Ru, at least 1 wt % of the promoter metal, and at least 1 wt % of the second metal as a percent of the total weight of the catalyst and support (if present).

Also disclosed herein is a method of making ammonia, the method comprising contacting H₂ and N₂ with a catalyst as disclosed herein, for a time, at a pressure, and at a temperature wherein at least a portion of the H₂ and N₂ react with one another to yield ammonia.

The objects and advantages of the invention will appear more fully from the following detailed description of the preferred embodiment of the invention made in conjunction with the accompanying drawings.

### BRIEF DESCRIPTION OF THE DRAWING

The patent or application file contains at least one drawing executed in color. Copies of this patent or patent application publication with color drawing(s) will be provided by the Office upon request and payment of the necessary fee.

FIG. 1 is a graph depicting ammonia production using a heterogenous catalyst comprising 1 wt % Ru, 2 wt % Alkali on a Pr₂O₃ support, tested at 30 bar, 36,000 mL/g_{cat}/hr, and a feed of 1:1 H₂:N₂ (stoichiometric). The added alkali metal, from top trace to bottom trace, was Cs, K, Rb, none, Na, and Li. The rate of ammonia production is given in mmol/g_{cat}/hour.

FIG. 2 is a graph depicting a host of 1 wt % Ru, 2 wt % Cs, 2 wt % metal/Pr₂O₃ catalysts tested at about 300 to about 430° C., 30 bar, 1:1 H₂:N₂ and 36,000 mL/g_{cat}/hr. The metals tested included Ag, Al, Ba, Bi, Ca, Cd, Ce, Co, Cr, Cu, Cs, Dy, Er, Eu, Fe, Ga, Gd, Hf, Ho, In, Ir, K, La, Li, Lu, Mg, Mn, Na, Nd, Ni, Pb, Rb, Re, Sc, Sm, Sn, Sr, Tb, Tm, V, Yb, Zn, and Zr. The results were compared to ruthenium catalyst without promotion or the cesium only promoted catalyst.

FIG. 3 is a graph depicting the test results shown in FIG. 2 at 400° C. The colors on the periodic table correspond to ammonia synthesis rates of the catalysts with the second metals tested. Various colors represent different ranges of the ammonia synthesis rate (no activity, <10, 10-15, 15-20, 20-25, 25-30, 30-35, and >35).

FIG. 4 is a contour plot of ammonia synthesis rate as a function of barium wt % and cesium wt % in the catalyst. All the catalysts tested were 1 wt % Ru, X wt % Cs, Y wt % Ba on a Pr₂O₃ support and tested at 400° C., 30 bar, 1:1 H₂:N₂ and 36,000 mL/g_{cat}/hr.

FIG. 5 is a contour plot of ammonia synthesis rate as a function of calcination time and temperature of the promoted support during preparation of the catalyst. The plot shows the effect of calcination time and temperature for the decomposition/reduction of the promoter precursors on the ammonia synthesis rate. The catalysts tested were 1 wt % Ru, 2 wt % Cs, 2 wt % Ba on a Pr₂O₃ support and tested at 400° C., 30 bar, 1:1 H₂:N₂ and 36,000 mL/g_{cat}/hr.

FIG. 6 is a contour plot of ammonia synthesis rate as a function of argon calcination time and temperature during preparation of the catalyst. The plot shows the effect of argon calcination time and temperature for the decomposition of ruthenium precursors on the ammonia synthesis rate. The catalysts tested were 1 wt % Ru, 2 wt % Cs, 2 wt % Ba on a Pr₂O₃ support and tested at 400° C., 30 bar, 1:1 H₂:N₂ and 36,000 mL/g_{cat}/hr.

FIG. 7 is a contour plot of ammonia synthesis rate as a function of the reduction time and temperature in the reaction cycle. The plot shows the effect of the reduction time and temperature on the ammonia synthesis rate. The catalysts tested were 1 wt % Ru, 2 wt % Cs, 2 wt % Ba on a Pr₂O₃ support and tested at 400° C., 30 bar, 1:1 H₂:N₂, and 36,000 mL/g_{cat}/hr.

FIG. 8 is a graph depicting ammonia synthesis rate as a function of reaction temperature. The catalyst tested was 1 wt % Ru, 4.12 wt % Cs, 3.86 wt % Ba on a Pr₂O₃ support and tested at about 305 to about 405° C., 30 bar, 1:1 H₂:N₂, and 36,000 mL/g_{cat}/hr.

FIG. 9 is a graph depicting ammonia synthesis rate as a function of reaction time. The catalyst tested was 1 wt % Ru, 1 wt % Cs, 4 wt % Ba on a Pr₂O₃ support and tested at about 400° C., 30 bar, 1:1 H₂:N₂, and 36,000 mL/g_{cat}/hr for up to 72 hours. The experimental data is represented by square symbols, and the fitting data is indicated by dots.

FIG. 10 is a graph depicting the activity of a 1 wt % Ru/Pr₂O₃ catalyst over 23 reaction cycles and at different temperatures. Each cycle included reduction, pressurization, analysis, and depressurization. The color on the dots represents the temperature at which the analysis was conducted. The catalyst was tested at 30 bar, 1:1 H₂:N₂, and 36,000 mL/g_{cat}/hr.

FIG. 11 is a graph depicting the activity of a 0.2 wt % Ru, 2 wt % Cs/Pr₂O₃ catalyst over seven cycles of catalysis. Each cycle included reduction, pressurization, analysis, and depressurization. This catalyst was tested at 399° C., 30 bar, 1:1 H₂:N₂, and 36,000 mL/g_{cat}/hr.

### DETAILED DESCRIPTION

### Abbreviations and Definitions

The term “transition metal” means any element in Groups 3-12 of the period table of elements (i.e., d-block elements). Thus, included within the definition are scandium, titanium, vanadium, chromium, manganese, iron, cobalt, nickel, copper, zinc, yttrium, zirconium, niobium, molybdenum, technetium, ruthenium, rhodium, palladium, silver, cadmium, lanthanum, hafnium, tantalum, tungsten, rhenium, osmium, iridium, platinum, gold, mercury, actinium, rutherfordium, dubnium, seaborgium, bohrium, hassium, meitnerium, darmstadtium, roentgenium, and copernicium.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 1 to 9, from 3.6 to 4.6, from 3.5 to 9.9, and so forth.

All references to singular characteristics or limitations of the disclosed method shall include the corresponding plural characteristic or limitation, and vice-versa, unless otherwise specified or clearly implied to the contrary by the context in which the reference is made. The indefinite articles “a” and “an” mean “one or more.”

As used herein, the term “or” is an inclusive “or” operator and is equivalent to the term “and/or” unless the context clearly dictates otherwise.

All combinations of method steps disclosed herein can be performed in any order, unless otherwise specified or clearly implied to the contrary by the context in which the referenced combination is made.

The methods and compositions of matter disclosed herein can comprise, consist of, or consist essentially of the essential elements and steps described herein, as well as any additional or optional ingredients, components, or limitations described herein or otherwise useful in the fields of supported catalysts and/or heterogenous catalysis. The disclosure provided herein suitably may be practiced in the absence of any element which is not specifically disclosed herein.

### The Catalyst and its Use

Presently, there are a host of catalysts that can be used to catalyze the production of ammonia via the Haber-Bosch process. Yet, despite more than a century of research, the Haber-Bosch process still is very energy intensive due to the need for high pressures and temperatures. There remains an unmet need for catalysts that will efficiently catalyze the reaction at lower pressures and temperatures.

Newly developed and disclosed herein are ruthenium-based catalysts and a method of making ammonia from H₂ and N₂ using the catalysts.

The catalyst comprises ruthenium, a promoter metal, and a second metal. The promoter metal is preferably (but non-exclusively) selected from the group consisting of Li, Na, K, Rb, and Cs. The second metal is preferably (but non-exclusively) a transition metal. Preferred metals for use as the second metal include (but are not limited to) Ag, Al, Ba, Bi, Ca, Cd, Ce, Co, Cr, Cu, Cs, Dy, Er, Eu, Fe, Ga, Gd, Hf, Ho, In, Ir, K, La, Li, Lu, Mg, Mn, Na, Nd, Ni, Pb, Rb, Re, Sc, Sm, Sn, Sr, Tb, Tm, V, Y, Yb, Zn, and Zr.

The catalyst may optionally be disposed on a support. When the catalyst is disposed on a support, an exemplary, non-limiting, and preferred support comprises praseodymium oxide.

The amount of ruthenium, the promoter metal, and the second metal is not particularly limited. With respect to the total weight of the catalyst and support (if present), the amount of ruthenium is 0.01 wt % or more, 0.02 wt % or more, 0.05 wt % or more, 0.1 wt % or more, 0.2 wt % or more, 0.3 wt % or more, 0.4 wt % or more, or 0.5 wt % or more, and the amount of ruthenium is 30% wt % or less, 20% wt % or less, 10% wt % or less, 5 wt % or less, 3 wt % or less, 2 wt % or less, or 1 wt % or less. Preferably, the amount of ruthenium is less than 3 wt %, less than 2 wt %, or less than 1 wt %.

With respect to the total weight of the catalyst and support (if present), the amount of the promoter metal is 0.5 wt % or more, 1 wt % or more, 2 wt % or more, 3 wt % or more, 4 wt % or more, 5 wt % or more, 6 wt % or more, 7 wt % or more, 8 wt % or more, 9 wt % or more, 10 wt % or more, 15 wt % or more, 20 wt % or more, or 30 wt % or more. With respect to the total weight of the catalyst and support (if present), the amount of the second metal is 0.5 wt % or more, 1 wt % or more, 2 wt % or more, 3 wt % or more, 4 wt % or more, 5 wt % or more, 6 wt % or more, 7 wt % or more, 8 wt % or more, 9 wt % or more, 10 wt % or more, 15 wt % or more, 20 wt % or more, or 30 wt % or more.

The catalyst disclosed herein is suitable for use in ammonia synthesis. The catalysts show high activity for ammonia synthesis, even with relatively low weight loadings of ruthenium, in comparison to current catalysts. Additionally, the catalysts can operate at lower temperatures and pressures to reduce energy consumption compared to iron-based industrial catalysts.

Thus, disclosed herein is a method of making ammonia, the method comprising contacting H₂ and N₂ with a catalyst as disclosed herein, for a time, at a pressure, and at a temperature wherein at least a portion of the H₂ and N₂ react with one another to yield ammonia.

The H₂ and N₂ may be contacted with the catalyst at a temperature of 500° C. or less, preferably, 400° C. or less, and the H₂ and N₂ may be contacted with the catalyst at a temperature of 250° C. or more, or 300° C. or more. The H₂ and N₂ may be contacted with the catalyst at a pressure of 50 bar or less, preferably, 30 bar or less, and the H₂ and N₂ may be contacted with the catalyst at a pressure of 10 bar or more.

### Catalyst Preparation

The praseodymium oxide support was produced by precipitating 0.5 M praseodymium nitrate (Sigma Aldrich, St. Louis, Missouri) dissolved in deionized (“DI”) water, dropped at a 2 mL/min rate into ammonium hydroxide (Sigma Aldrich). Precipitate was stirred for an additional 2 hours, before allowing to settle for 4 hours. The mixture was then filtered using a Buchner funnel, with multiple DI water washes. The filtrate was then allowed to dry over 4 days, before being calcined in an oven under air. The calcination was started at 120° C. before ramping at 2.5° C./min to 700° C. The final temperature was held for 5 hours before allowing the catalysts to cool at 2.5° C./min to room temperature.

Promotion of the catalysts was conducted using incipient wetness impregnation of precursors dissolved in DI water. Cobalt nitrate, copper nitrate and lithium acetate were sourced from Acros Organics (Geel, Belgium); nitrates of aluminum, barium, calcium, europium, gallium, gadolinium, holmium, indium, lanthanum, lutetium, nickel, samarium, yttrium, ytterbium and zinc, potassium acetate and scandium acetate were sourced from Alfa Aesar (Ward Hill, Massachusetts); nitrates of bismuth, cadmium, dysprosium, erbium, lead, strontium and terbium, acetates of cesium, iridium and sodium, hafnium acetylacetonate, vanadium acetylacetonate and zirconium dinitrate oxide were sources from Fisher Scientific (Waltham, Massachusetts); nitrates of silver, cerium, chromium, iron, magnesium, manganese neodymium and thulium, ammonium perrhenate, and tin acetate were sourced from Sigma Aldrich; and rubidium acetate was sourced from Strem Chemicals (Newburyport, Massachusetts). Catalysts were produced in 2 g samples, before being dried at 120° C. and calcined for 1 hour at 650° C. to remove all ligands.

Ruthenium was added using a trirutheniun dodecacarbonyl (Sigma Aldrich) precursor:

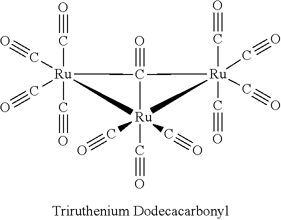

The catalysts were made via wetness impregnation. The ruthenium was dissolved in tetrahydrofuran (Fisher Scientific) and stirred vigorously before the promoted support was added. The tetrahydrofuran was evaporated. Upon removal of the THF solvent, the samples were transferred to a Lindberg/Blue furnace (Lindberg/MPH, Riverside, Michigan) which was heated under argon (Airgas, Radnor Township, Pennsylvania) to 350° C. and held for 3 hours to decompose the ruthenium precursor.

### Catalyst Evaluation

0.2 g of each catalyst were tested in a four-channel parallel reactor, with K-type thermocouples measuring the temperature in each reactor. Each catalyst was tested following a one-hour reduction at 500° C. before being cooled under the reaction mixture of hydrogen (Airgas) and nitrogen (Airgas). Hydrogen and nitrogen were introduced into the reactor at a 1:1 ratio. Each reactor was independently pressurized to 30 bar and heated between about 300° C. and 430° C. Effluent was analyzed by gas chromatography using a Shimadzu GC-2014 (Shimadzu Corporation, Kyoto, Japan) fitted with a Restek RTX-VolatileAmine column (Restek Corporation, Bellefonte, Pennsylvania).

The wetness impregnation process yielded highly dispersed metal atoms on the support. This led to very high activity exhibited by the catalyst, even at low weight loadings. The ruthenium loading on the catalyst supports can be altered/optimized based on the exact uses and requirements of the system being used. The catalysts disclosed and tested here were typically loaded at 1 wt % Ru/Pr₂O₃. Increasing the ruthenium loading will likely cause an increase in activity. The 1 wt % starting point was chosen because it struck a balance between performance and cost, allowing for much cheaper catalysts. Any wt % of ruthenium on the support is within the scope of the present disclosure.

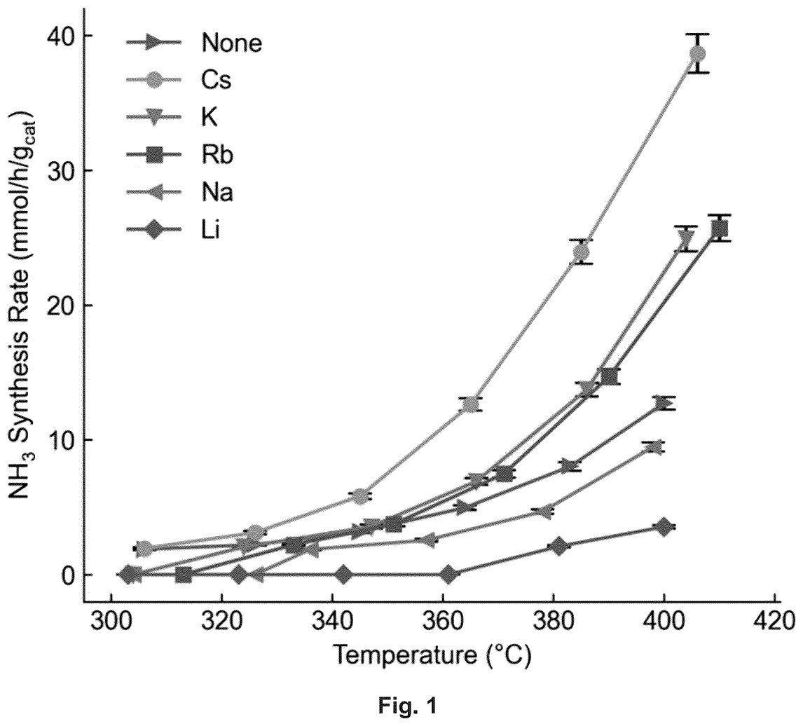

Promotion of ruthenium catalysts is known in the art. Typically only the first two columns of the periodic table are studied in great depth as promoters. Although, these elements are known to be strong electronic promoters (especially in terms of the alkali metals—i.e., Group 1 metals: Li, Na, K, Rb, Cs; see FIG. 1), a more complete study of dozens of metals was first undertaken to verify that there was not an arbitrary omission of a promising promoter. As a result, testing of 44 promoters was undertaken. Due to solubility issues of the precursors for the ruthenium and the promoters, a sequential impregnation of promoters then a calcination before the ruthenium impregnation was used.

To start, the activities of the alkali metal-promoted catalysts were studied (FIG. 1). A 1 wt % Ru, 2 wt % Alkali/Pr₂O₃ formulation was chosen. As shown in FIG. 1, cesium (Cs) showed the highest activity, almost tripling the activity of the unpromoted catalyst.

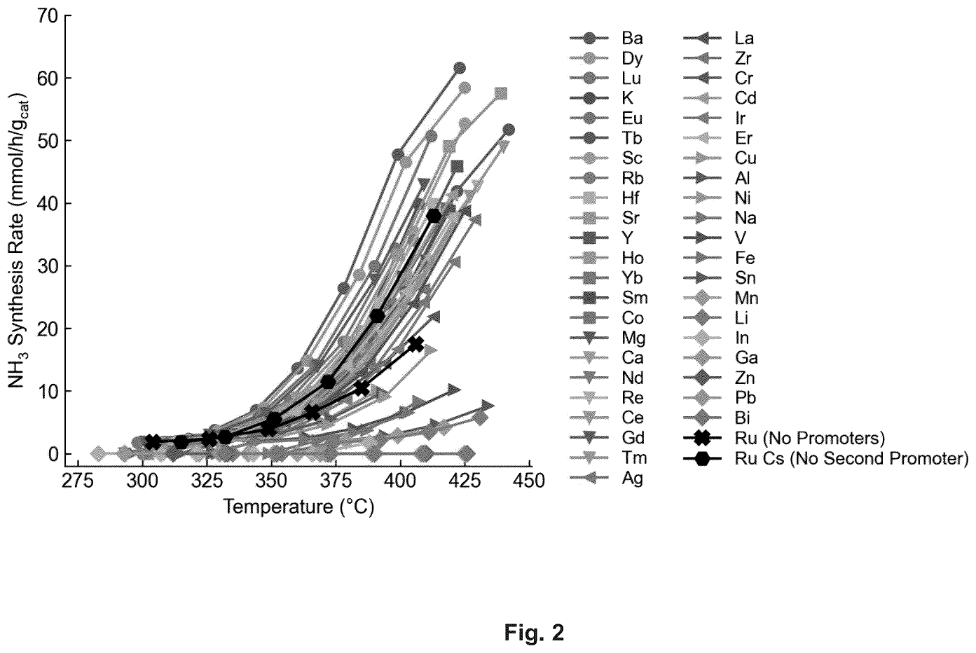

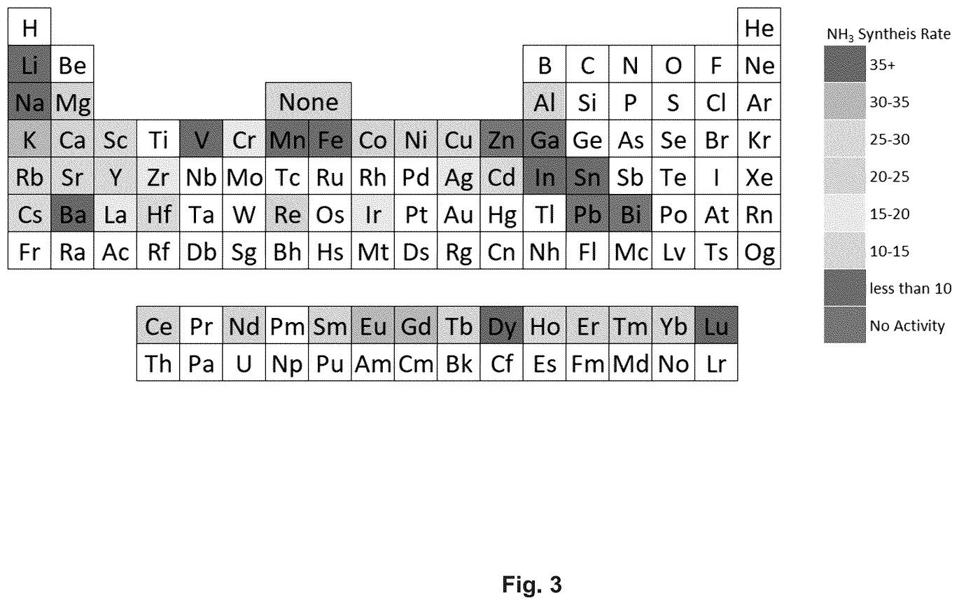

Further catalysts were then evaluated using an exemplary composition comprising 1 wt % Ru, 2 wt % Cs, and 2 wt % of a second metal, all deposited on a Pr₂O₃ support. The results are presented in FIG. 2. Here, many catalysts performed within approximately 5 mmol/g_{cat}/hr of the singly-promoted catalyst (1 wt % Ru and 2 wt % Cs; no second promoter). Despite this, a few catalysts produced either much more, or very little ammonia. Of the 43 doubly-promoted catalysts, 10 increased in activity when compared with the cesium-only promoted catalyst, including Ba, Dy, Lu, Gd, Eu, K, Sc, Sr, Hf, and Y. As can be seen from FIG. 3, the promoters in the first three columns of the periodic table have shown high activity for the ruthenium-based catalysts. This does include, however, the lanthanides, which also demonstrate high performance as promoters.

Comparing this to an iron-based industrial catalyst, the best catalyst tested is approximately seven times higher in activity. The KM1R catalyst is an optimized, commercially available catalyst for ammonia production that uses iron as the catalytically active metal. (Topsoe A/S, Lyngby, Denmark.) This activity of the KM1R catalyst was used as a benchmark for testing the activity of the catalysts disclosed herein. The reactions with KM1R were conducted under the same process and conditions described herein and yielded ammonia at a rate of 7.56 mmol/g_{cat}/hr at 30 bar, 1:1 H₂:N₂, and 401° C. By way of comparison, the 1 wt % Ru, 3.86 wt % Ba, 4.12 wt % Cs/Pr₂O₃ catalyst disclosed herein produced ammonia at a rate of 65.4 mmol/g_{cat}/hr under the same condition—a very surprising and gratifying 8-fold+ improvement in activity. Furthermore, the ruthenium-based catalysts disclosed herein reach peak operating activity after approximately one hour (although the main increase in activity is in the first thirty minutes), which allows for on-off cycling to occur, if needed or desired.

Table 1 shows test results for a host of catalysts fabricated according to the present disclosure. They all had markedly improved activity as compared to the conventional KM1R catalyst.

Table 1: Various catalysts tested at 400° C., 30 bar, 1:1 H₂:N₂, and 36000 mL/g_{cat}/hr.

| | Ammonia | Ammonia |
|---|---|---|
| | Synthesis | Synthesis |
| | Rate (mmol/ | Rate (g_{NH3}/ |
| Catalyst | g_{cat}/hr) | g_{cat}/day) |
| 1 wt % Ru 6 wt % Ba 4 wt % Cs/Pr₂O₃ | 65.64 | 26.83 |
| 1 wt % Ru 4 wt % Ba 4 wt % Cs/Pr₂O₃ | 56.95 | 23.28 |
| 1 wt % Ru 2 wt % Ba 2 wt % Cs/PrDyOₓ | 38.70 | 15.82 |
| 1 wt % Ru/PrDyOₓ | 25.32 | 10.35 |
| 1 wt % Ru/Pr₂O₃ | 12.71 | 5.20 |
| 1 wt % Ru 2 wt % Ba 2 wt % Cs/Pr₂O₃ | 47.76 | 19.52 |
| 1 wt % Ru 2 wt % Ba 2 wt % Cs/CeO₂ | 26.97 | 11.02 |
| 0.2 wt % Ru 4 wt % Ba 4 wt % Cs/Pr₂O₃ | 11.50 | 4.70 |
| 0.2 wt % Ru 4 wt % Ba 4 wt % Cs 4 wt | 12.62 | 5.16 |
| % Dy/Pr₂O₃ | | |
| 5 wt % Ru 4 wt % Ba 4 wt % Cs/Pr₂O₃ | 53.59 | 21.90 |

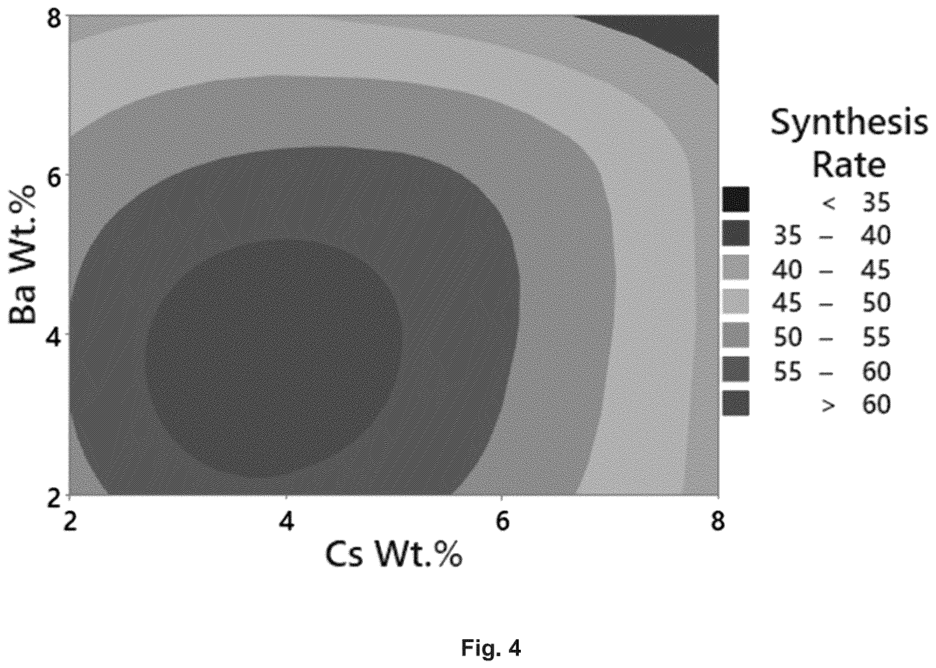

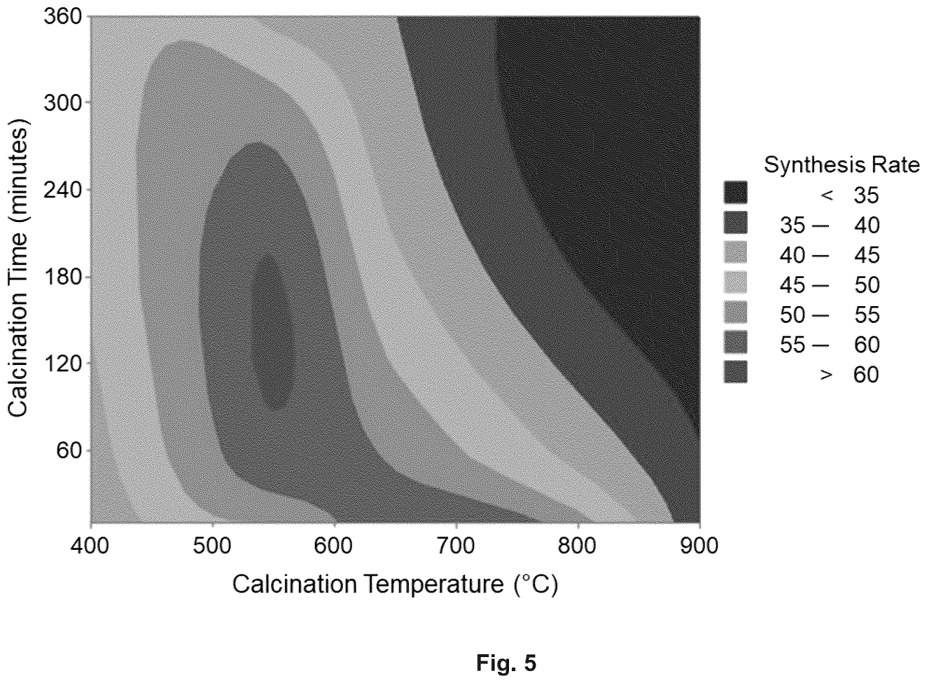

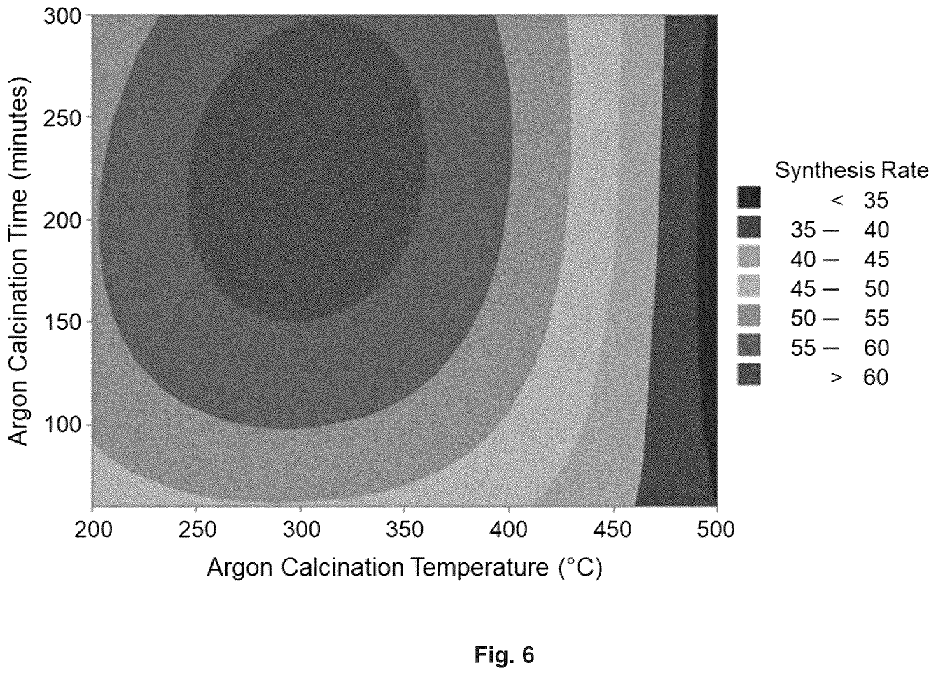

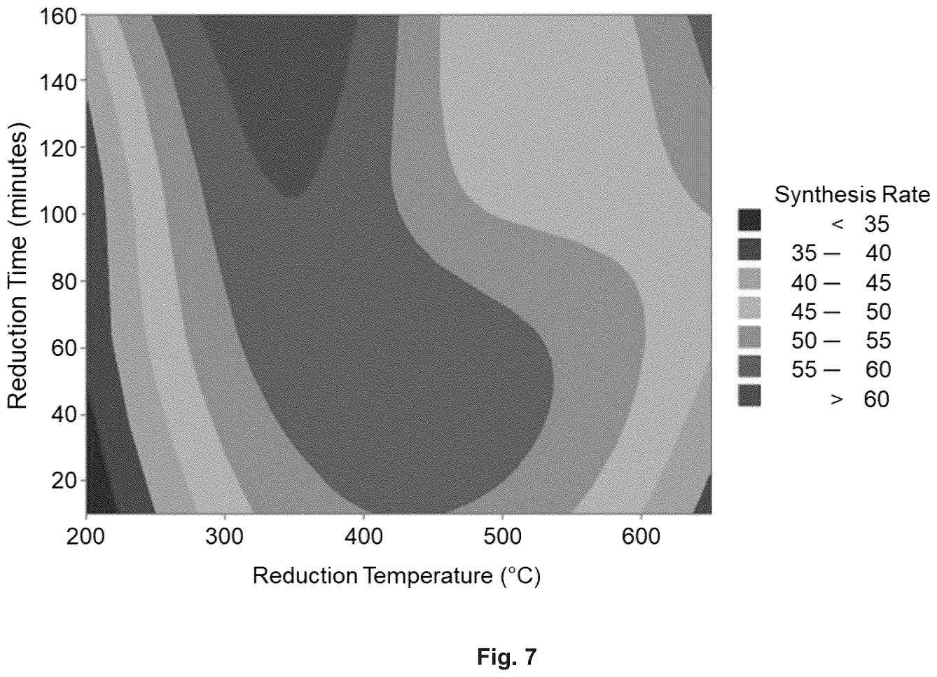

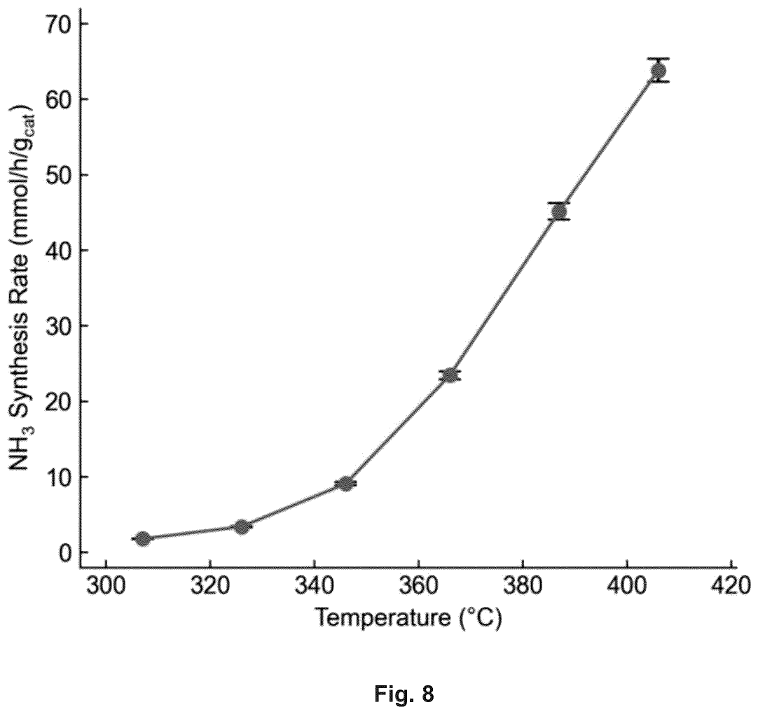

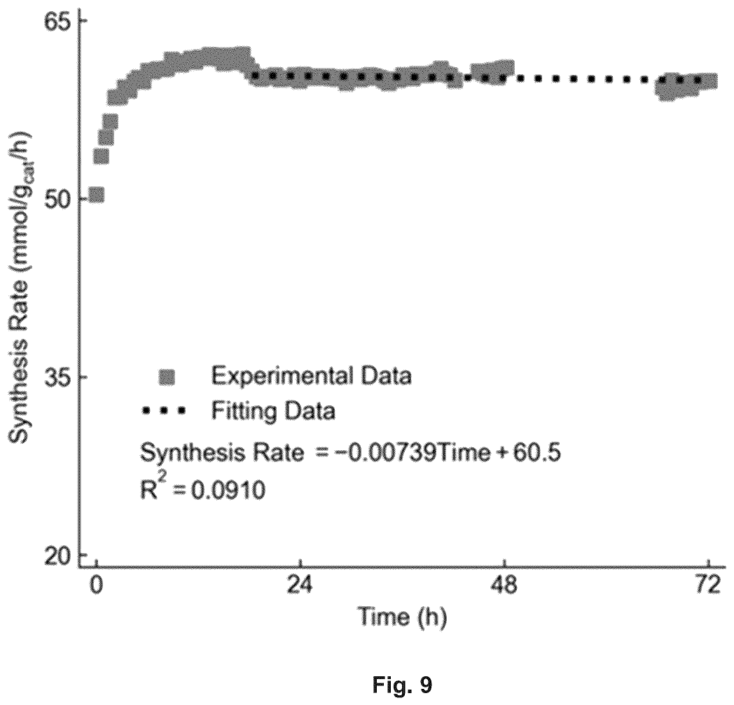

The composition of the catalyst, calcination time and temperature during catalyst preparation, and conditions of ammonia synthesis reaction using the catalyst can be optimized. Using barium (Ba) as an exemplary second metal, FIG. 4 shows ammonia synthesis rate as a function of Ba wt % and Cs wt % in the catalyst; FIG. 5 shows ammonia synthesis rate as a function of calcination time and temperature of the promoted support during preparation of the catalyst; FIG. 6 shows ammonia synthesis rate as a function of argon calcination time and temperature for the decomposition of ruthenium precursors during preparation of the catalyst; FIG. 7 shows ammonia synthesis rate as a function of the reduction time and temperature during the reaction cycle; FIG. 8 shows ammonia synthesis rate as a function of reaction temperature; and FIG. 9 shows ammonia synthesis rate as a function of reaction time. Detailed catalyst compositions and reaction conditions are provided in the Brief Description of the Drawings.

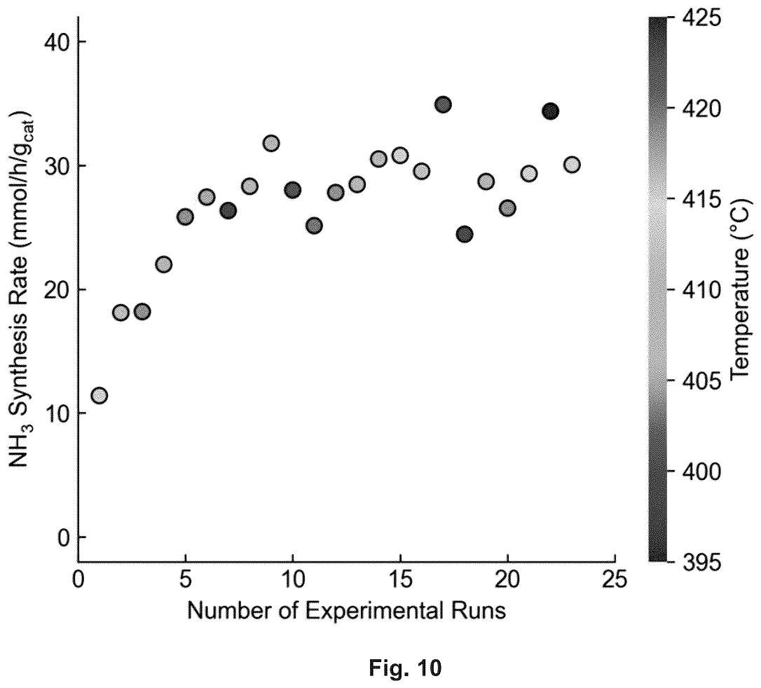

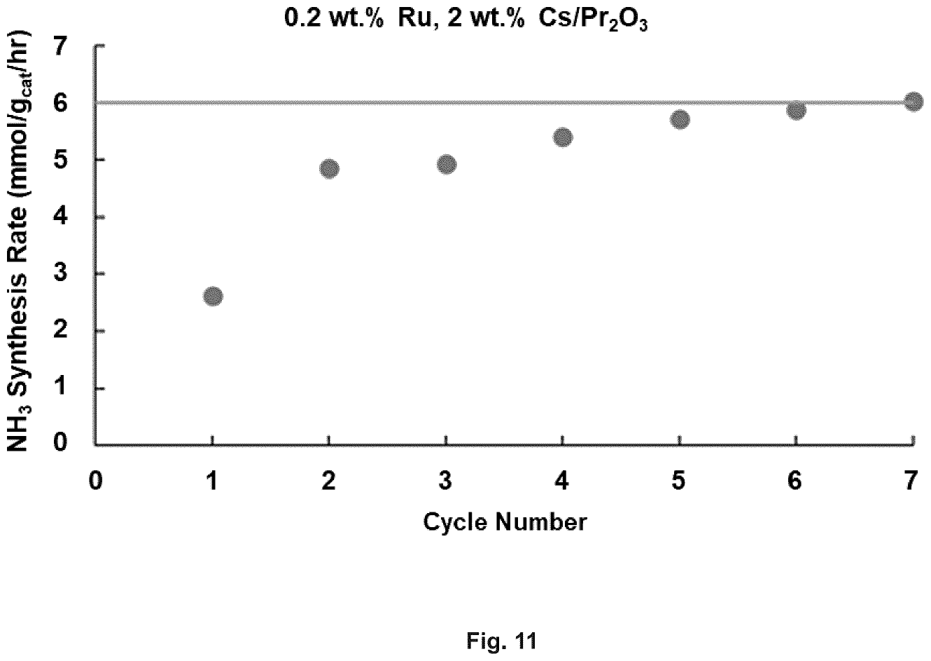

The catalysts were also tested using a single cycle of reduction, pressurization, operation, and depressurization. When this process was repeated for the unpromoted catalyst, improvements occurred. As shown in FIG. 10, activity increased for the first seven cycles, nearly tripling the initial activity. After this, the activity stabilized, and was still performing highly nearly six weeks after the initial run, thus showing the stability of the catalysts. A similar trend was observed for a 0.2 wt % Ru, 2 wt % Cs/Pr₂O₃ catalyst, as shown in FIG. 11.

What is claimed is:

1. A catalyst comprising ruthenium, a promoter metal, and a second metal.

2. The catalyst of claim 1, wherein the promoter metal is selected from the group consisting of Li, Na, K, Rb, and Cs.

3. The catalyst of claim 1, wherein the second metal is a transition metal.

4. The catalyst of claim 1, wherein the second metal is selected from the group consisting of Ag, Al, Ba, Bi, Ca, Cd, Ce, Co, Cr, Cu, Cs, Dy, Er, Eu, Fe, Ga, Gd, Hf, Ho, In, Ir, K, La, Li, Lu, Mg, Mn, Na, Nd, Ni, Pb, Rb, Re, Sc, Sm, Sn, Sr, Tb, Tm, V, Y, Yb, Zn, and Zr.

5. The catalyst of claim 1, wherein the second metal is selected from the group consisting of Ba, Dy, Eu, Gd, Hf, K, Lu, Sc, Sr, and Y.

6. The catalyst of claim 1, wherein the ruthenium, promoter metal, and second metal are disposed on a support.

7. The catalyst of claim 6, wherein the support comprises praseodymium oxide.

8. The catalyst of claim 1, wherein the promoter metal is Cs.

9. The catalyst of claim 1, wherein the second metal is Ba.

10. The catalyst of claim 1, comprising at least 0.2 wt % Ru as a percent of the total weight of the catalyst and support (if present).

11. The catalyst of claim 1, comprising less than 3 wt % Ru as a percent of the total weight of the catalyst and support (if present).

12. The catalyst of claim 1, comprising at least 1 wt % of the promoter metal, as a percent of the total weight of the catalyst and support (if present).

13. The catalyst of claim 1, comprising at least 1 wt % of the second metal, as a percent of the total weight of the catalyst and support (if present).

14. A method of making ammonia, the method comprising contacting H₂ and N₂ with a catalyst as recited in claim 1, for a time, at a pressure, and at a temperature wherein at least a portion of the H₂ and N₂ react with one another to yield ammonia.
